(19) United States
(12) Patent Application Publication
(10) Pub. No.: US 2012/0221348 A1
(43) Pub. Date: Aug. 30, 2012

(54) IDENTIFYING A DEVIATION DURING CLINICAL PATHWAY EXECUTION

(75) Inventors: Feng Cao, Beijing (CN); Gang Hu, Beijing (CN); Bo Li, Shanghai (CN); Jing Li, Beijing (CN); Xiao Yuan Wang, Zhangjinag (CN)

(73) Assignee: International Business Machines Corporation, Armonk, NY (US)

(21) Appl. No.: 13/404,881

(22) Filed: Feb. 24, 2012

(30) Foreign Application Priority Data
Feb. 28, 2011 (CN) 201110051565.9

(51) Int. Cl. G06Q 50/22

(52) U.S. Cl. 705/2

(57) ABSTRACT

A system and method for identifying a deviation during clinical pathway execution. The system comprises: a clinical pathway storage component configured to store a clinical pathway; a semantic relationship storage component configured to store a semantic relationship between activities; a receiver component configured to receive an activity inputted from a user; and an activity matching component configured to judge, based on the semantic relationship between activities, whether the inputted activity matches the requisite activity defined in the clinical pathway, and if it is determined that the inputted activity does not match the requisite activity defined in the clinical pathway, generate a first clinical pathway execution deviation report, wherein the first clinical pathway execution deviation report indicates that an undefined redundant activity is executed. This permits the precision of identifying deviation during clinical pathway execution to be improved.

### CROSS REFERENCE TO RELATED APPLICATION

This application claims priority under 35 USC§119 from Chinese Patent Application No. 201110051565.9 filed Feb. 28, 2011, the entire contents of which are incorporated herein by reference.

### FIELD OF THE INVENTION

The present invention relates to information processing and more specifically to a system and method for identifying a deviation during clinical pathway execution.

### BACKGROUND

Nowadays, most countries in the world are being challenged by the great gaps between the demand for medical services and healthcare resources (including both healthcare facilities and workforce resources).

Clinical pathways are widely used during healthcare in many developed countries, and they can increase the operating efficiency of hospitals, improve the quality of healthcare and reduce healthcare costs.

A clinical pathway is relative to a traditional pathway. A traditional pathway refers to each physician's personal pathway. Different areas, hospitals, treatment groups or even physicians might use different treatment plans (i.e., using different personal pathways) for a certain disease. By using a clinical pathway, however, it is possible to avoid different treatment plans for the same disease among different areas, hospitals, treatment groups or physicians, thereby preventing the arbitrariness of treatment and enhancing the predictability of costs, post-treatment and so on.

Sometimes deviation might occur during the execution of a clinical pathway; that is, the actual execution of treatment deviates from a standard clinical pathway. There are positive deviation and negative deviation. A negative deviation means that a planned activity is not executed or the execution is delayed; for example, a CT check is delayed, etc. A positive deviation means that a planned activity is executed in advance; for example, a CT check is performed in advance, etc.

Currently, deviations during clinical pathway executions are identified manually, which is inefficient and imprecise.

Therefore, there is a need for a solution capable of automatically identifying the deviations during clinical pathway execution.

### SUMMARY OF THE INVENTION

The present invention provides a system and method for identifying the deviation during clinical pathway execution.

According to a first aspect of the present invention, a system for identifying the deviation during clinical pathway execution comprises: a receiver component configured to receive an activity inputted from a user; a clinical pathway repository component configured to access a stored clinical pathway, the clinical pathway defining a requisite activity; and an activity matching component configured to judge, based on a semantic relationship between activities, whether the inputted activity matches the requisite activity as defined in the clinical pathway, and generate, if it is judged that the inputted activity does not match the requisite activity as defined in the clinical pathway, a clinical pathway execution deviation report to indicate that an activity not matching the requisite activity has been executed.

According to a second aspect of the present invention, a method of identifying the deviation during clinical pathway execution comprises: receiving an activity inputted from a user; accessing a stored clinical pathway, the clinical pathway defining requisite activities; and judging, based on the semantic relationship between activities, whether the inputted activity matches any requisite activity defined in the clinical pathway, and generating, if it is judged that the inputted activity does not match the requisite activity as defined in the clinical pathway, a clinical pathway execution deviation report to indicate that an activity not matching the requisite activity has been executed.

According to the present invention, it is possible to improve the precision of identifying the deviation during clinical pathway execution.

### BRIEF DESCRIPTION OF THE DRAWINGS

In describing preferred or illustrative embodiments, reference is made to the accompanying drawings, wherein like numerals represent the same, similar or corresponding features or functions throughout the figures, and wherein:

FIG. 1 illustrates a system in which the present invention can be implemented;

FIG. 2 illustrates a block diagram of a system for identifying the deviation during clinical pathway execution according to one embodiment of the present invention;

FIG. 3 illustrates relationships between six types during clinical pathway execution deviation reports; and

FIG. 4 illustrates a flowchart of a method of identifying the deviation during clinical pathway execution according to one embodiment of the present invention.

### DETAILED DESCRIPTION OF THE PREFERRED EMBODIMENT

Reference will be made to the figures to describe specific embodiments of a solution of identifying a deviation during clinical pathway execution as provided by the present invention. Many details are explained in the following description for a more comprehensive understanding of the present invention. However, persons skilled in the art will readily appreciate that the present invention may be implemented without some of these details, and the present invention is not limited to specific embodiments to be described. On the contrary, any combinations of the following features and elements may be considered to implement the present invention, no matter whether they relate to different embodiments. Therefore, the following aspects, features, embodiments, and advantages are only for illustration and should not be regarded as elements or limitations of the appended claims, unless otherwise specified in the claims explicitly. Further, it should be pointed out that in order to prevent unnecessary details from blurring the present invention, the figures only illustrate apparatus structures and/or processing steps that are closely related to the solution of the preferred embodiments but omit other details that have little to do with the present invention. In addition, connections in the present application document include both direct connections and indirect connections unless limited with “direct” or “indirect” intentionally.

According to the ordinary procedure of identifying the workflow deviation, required data are mainly various attribute information of a single object, and a main method is a function operation. For example, it might be necessary to “audit the credit status of a borrower” during credit examination and approval of a bank. This activity strictly defines a function calculation procedure and the required input attribute data corresponding to the qualified credit status (for example, “a borrower's salary income must be more than two times of the monthly installment payment,” “a borrower should have no bad record of credit cards during the last three years”). Hence, to identify whether there is deviation in an actual working process, it is only necessary to perform calculation on the input attribute data with a predefined function and compare an output with a predefined result, and if the output is inconsistent with the predefined result, it is determined that there is a deviation in the actual working procedure.

In the procedure of identifying the deviation during clinical pathway execution, the data as mainly used are semantic relationships between concepts and the main method as adopted is semantic reasoning, because semantic relationships between healthcare concepts are rather complex.

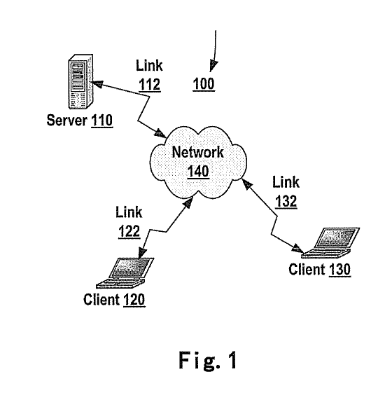

Turning now to specific embodiments of the present invention with reference to the figures, FIG. 1 illustrates a system 100 in which the present invention can be implemented. As illustrated in FIG. 1, system 100 comprises a server 110, two clients 120, 130, and a network 140. The server 110 and the clients 120, 130 may be laptops, minicomputers, medium-sized computers, etc. The server 110 is connected to the network 140 via a link 112, and the clients 120, 130 are connected to the network 140 via links 122, 132, respectively. That is, the clients 120, 130 may access the server 110 through the network 140. The links 112, 122, 132 may be wired links such as coaxial cables, optical fibers or the like, or wireless links such as satellite links or the like. Likewise, the network 140 may be a wireless network, a wired network, or a combination thereof. In addition, the network 140 may be a local area network, a metropolitan area network, a wide area network, or a combination thereof. One example of the network 140 is the Internet.

Of course, those skilled in the art should understand that other clients may be connected over the network 140. In order to differentiate from one another, the clients and the server may have identifiers capable of identifying them uniquely, such as IP address, Uniform Resource Locators (URLs), etc.

The system for identifying the deviation during clinical pathway execution according to the present invention may be located in the server 110. Users (more specifically, medical care personnel) may access the system through the client 120 or 130 for identifying the deviation during clinical pathway execution. For example, users may open the browser in the client 120 and input the address of the server 110 into the browser, thereby accessing the system for identifying any deviation during clinical pathway execution. Users may further input corresponding information into a page opened as such, so as to provide corresponding information to the system. Furthermore, the system may report any identified deviation during clinical pathway execution to users in real time and/or periodically (for example, through the browser in the client 120), which will be described in detail hereinafter.

Of course, those skilled in the art should understand that the present invention is not limited to the foregoing situation. For example, the present invention may be implemented in an environment in which there is only a single computer (i.e., in a single-computer model rather than the above server-clients model).

Before an embodiment is described in detail, a brief introduction is first presented to content that may be contained in a clinical pathway.

The following content schematically illustrates a clinical pathway:

Phase 1:
first day after admission
Activities:
. . .

. . .

Phase n:
3 days before discharge
Activities:
   Complete health check
      BloodSugarTestFailed: BloodSuger>1.2 *Average BloodSuger of Same comparing group
      If BloodSugarTestFailed then complete health check is compulsory

As illustrated above, a clinical pathway comprises one or more phases, and each phase has corresponding requisite treatment activities. The execution of some requisite treatment activities must satisfy preconditions, whereas some requisite treatment activities are executed without preconditions. Moreover, each requisite treatment activity is generally subjected to a time restriction, i.e., a clinical pathway generally specifies which requisite activity is performed under what condition at which time.

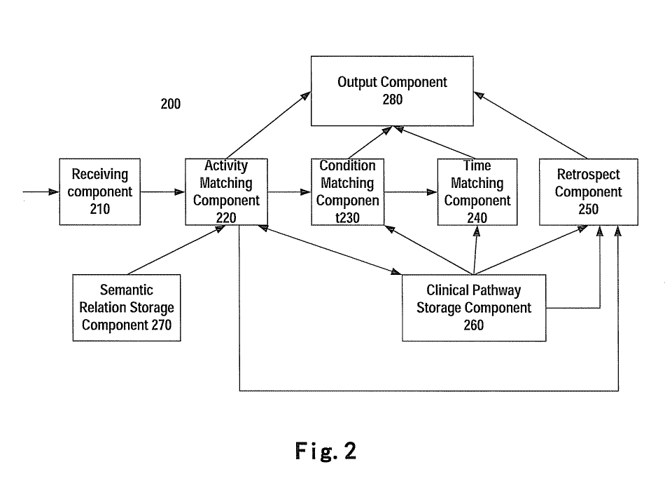

FIG. 2 illustrates a block diagram of a system for identifying the deviation during clinical pathway execution according to an embodiment of the present invention. As illustrated in FIG. 2, the system 200 comprises a clinical pathway storage component 260, a semantic relationship storage component 270, a receiver or receiving component 210, an activity matching component 220, and an output component 280.

The clinical pathway storage component 260 has clinical pathways stored therein.

The semantic relationship storage component 270 stores semantic relationships between activities. For example, the semantic relationship storage component 270 has SNOMED CT (Systemized Nomenclature of Medicine—Clinical Terms). SNOMED CT consist of concepts, conceptual IDs, descriptions, attributes, hierarchies, and relationships, among which concepts, descriptions, and relationships are core elements of SNOMED CT.

The receiver component 210 receives information inputted from users (i.e., medical care personnel). The information inputted from users at least comprises names of activities, corresponding execution times, and corresponding names of clinical pathways (names of clinical pathways are for the first time, and thereafter, they can be names of instances).

The activity matching component 220 noted above is for judging, based on semantic relationships between activities, whether an inputted activity matches a requisite activity that is defined in a corresponding clinical pathway. If it is determined that the inputted activity does not match the requisite activity defined in the corresponding clinical pathway, it generates a first clinical pathway execution deviation report (indicating that an undefined redundant requisite activity is executed) and provides it to the output component 280.

Some activities (e.g., admission) mark the start of clinical pathway execution. Hence, when the activity matching component 220 finds a match with such an activity, it instantiates a clinical pathway and assigns an instance name thereto. The instance name can be, for example, a clinical pathway name_id (the clinical pathway instance may be, for example, temporarily stored in the clinical pathway storage component). Some activities (e.g., discharge) mark the end of clinical pathway execution. Hence, when the activity matching component 220 finds a match with such an activity, it may trigger the output component 280 to output a clinical pathway execution deviation report (if any) to a user. Of course, those skilled in the art may understand that it is possible to output the clinical pathway execution deviation report to the user in real time, without waiting for the end of the procedure of clinical pathway execution. It is even possible to output the clinical pathway execution deviation report to the user based on a combination of these two manners.

If the output component 280 does not output the clinical pathway execution deviation report to the user in real time, the clinical pathway execution report may be buffered in the output component 280.

Comparatively complicated semantic relationships exist between healthcare concepts (i.e., activities). Hence, a core step of identifying the deviation during clinical pathway execution is to infer whether two healthcare concepts contain a semantic corresponding relationship. If yes, it is determined that it is not a deviation of corresponding clinical pathway execution.

Inventors of the present invention realize that a correct reasoning result can be obtained only by using subsumption (“isA”) and composition (“isPartOf”) relationships in SNOMED CT as reasoning basis. Use of any other existing relationships in SNOMED CT might lead to a wrong reasoning result.

For example, manipulation of parathyroid gland (procedure site=parathyroid structure) and operation on transposed parathyroid gland (procedure site=parathyroid structure) have the same procedure site, i.e., parathyroid structure. If the procedure site relationship is used as a reasoning basis, i.e., it is considered that two activities with the same procedure site match, then it will arrive at a conclusion that manipulation of parathyroid gland and operation on transposed parathyroid gland match each other. In fact, manipulation of parathyroid gland and operation on transposed parathyroid gland do not match each other at all. That is to say, use of the procedure site relationship will yield a wrong reasoning result.

As another example, combination treatment to ankle (procedure site-direct=ankle region structure) and transposition of ankle tissue (procedure site-direct=ankle region structure) have the same direct procedure site, i.e., ankle region structure. If the procedure site-indirect relationship is used as the reasoning basis, i.e., it is considered that two activities with the same procedure site-direct match, then it will arrive at a conclusion that combination treatment to ankle and transposition of tissue of ankle match each other. In fact, combination treatment to ankle and transposition of tissue of ankle do not match each other at all. That is to say, use of the procedure site-indirect relationship will yield a wrong reasoning result.

As the simplest example to judge, based on semantic relationships between activities, whether an activity inputted from a user matches a requisite treatment activity defined in a clinical pathway, according to SNOMED CT, a venous blood test “isA” blood test, and a blood test “isPartOf” a health check; if a clinical pathway defines a blood test as a requisite treatment activity and an activity inputted from a user is a venous blood test, then it is decided that the activity inputted by the user matches the requisite activity defined in the clinical pathway (whereas the prior art decides that the activity inputted by the user does not match the requisite activity defined in the clinical pathway).

If the clinical pathway defines a health check as a requisite treatment activity and the activity inputted by the user is a venous blood test, then it is decided that the activity inputted by the user partially matches the requisite activity defined in the clinical pathway. That is to say, although the activity inputted by the user is a correct activity, the execution of the requisite activity defined in the clinical pathway is incomplete (whereas the prior art decides that the activity inputted by the user does not match the requisite activity defined in the clinical pathway).

Besides, regardless of whether the activity inputted by the user matches the requisite activity defined in the clinical pathway, the activity matching component 220 will record the activity inputted by the user in a corresponding clinical pathway instance.

The system 200 may further comprise a condition matching component 230 for determining whether the execution of the inputted activity, which is determined by the activity matching component 220 to match the requisite activity as defined in the clinical pathway, satisfies a precondition of the requisite activity, and if not, generating a second clinical pathway execution deviation report (indicating that a redundant treatment activity not satisfying a precondition is executed) and providing it to the output component 280.

As described above, the execution of some activities needs to satisfy preconditions. For example, a complete health check is required only when a blood sugar test fails.

The system 200 may further comprise a time matching component 240 for judging, under the condition that the condition matching component 230 determines that the execution of the inputted activity matching the requisite activity defined in the clinical pathway satisfies a precondition, whether the execution time of the inputted activity corresponds to the requisite execution time of the corresponding requisite activity defined in the clinical pathway, and if not, generating one of a third clinical pathway execution deviation report and a fourth clinical pathway execution deviation report and providing them to the output component 280. The third clinical pathway execution deviation report indicates that the treatment activity is executed in advance, i.e., the execution time of the inputted activity is earlier than the requisite execution time of the corresponding requisite activity defined in the clinical pathway; the fourth clinical pathway execution deviation report indicates that the execution of the treatment activity is delayed, i.e., the execution time of the inputted activity is later than the requisite execution time of the corresponding requisite activity defined in the clinical pathway.

The system 200 further comprises a retrospect component 250 for performing retrospect of all activities (for example, reviewing the corresponding clinical pathway instance wherein it is recorded which activities have been executed) inputted by the user if a time point arrives (for example, as described above, the user has inputted an activity (e.g., discharge) that marks the end during clinical pathway execution, or if the time of ending a phase arrives (for example, three days after admission; when the activity matching component 220 finds a match with an activity that marks the start of a phase, a timer may be triggered, and when the timer expires, the retrospect component 250 may be triggered)), so as to determine which requisite activities as defined in the clinical pathway are not executed and not completely executed up to this point in time. When it is determined that a requisite activity as defined in the clinical pathway is not executed, a fifth clinical pathway execution deviation report is generated (indicating a requisite treatment activity, which is defined in the clinical pathway, is not actually executed) and provided to the output component 280. When it is determined that a requisite activity as defined in the clinical pathway is not completely executed, a sixth clinical pathway execution deviation report is generated (indicating a requisite treatment activity that is defined in the clinical pathway but actually not completely executed) and provided to the output component 280. Actually, a requisite activity being not executed may be regarded as a special case of a requisite activity being not completely executed.

As described above, the activity matching component 220 may determine that an “isPartOf” relationship exists between the inputted activity and the requisite activity defined in the corresponding clinical pathway. In other words, the inputted activity is a part of the requisite activity defined in the corresponding clinical pathway. The retrospect component 250 determines whether other parts of the requisite activity defined in the corresponding clinical pathway are executed, and if it is determined that other parts of the requisite activity as defined in the corresponding clinical pathway are not executed, it will determine that the requisite activity defined in the clinical pathway is not completely executed.

More specifically, when the retrospect component 250 finds only one inputted activity having an “isPartOf” relationship with the requisite activity as defined in the corresponding clinical pathway, it may be determined definitely that the requisite activity as defined in the corresponding clinical pathway is not completely executed. When the retrospect component 250 finds that a plurality of inputted activities each of which has an “isPartOf” relationship with the requisite activity as defined in the corresponding clinical pathway, it is judged whether a combination of the plurality of inputted activities completely constitutes the requisite activity as defined in the corresponding clinical pathway. For example, by reviewing the semantic relationship storage component 270, it is determined whether the combination of the plurality of inputted activities completely constitutes the requisite activity as defined in the corresponding clinical pathway. When it is determined that the combination of the plurality of inputted activities completely constitutes the requisite activity as defined in the corresponding clinical pathway, then it is determined that the requisite activity as defined in the corresponding clinical pathway is completely executed; otherwise, it is determined that the requisite activity as defined in the corresponding clinical pathway is not completely executed.

For example, if a blood test and a heart test, which are both in “isPartOf” relationship with a health check, are executed and the semantic relationship storage component 270 defines that the health check includes the blood test and the heart test, then the retrospect component 250 determines that the activity of health check is completely executed.

As described above, the output component 280 may output six types during clinical pathway execution deviation reports to the user.

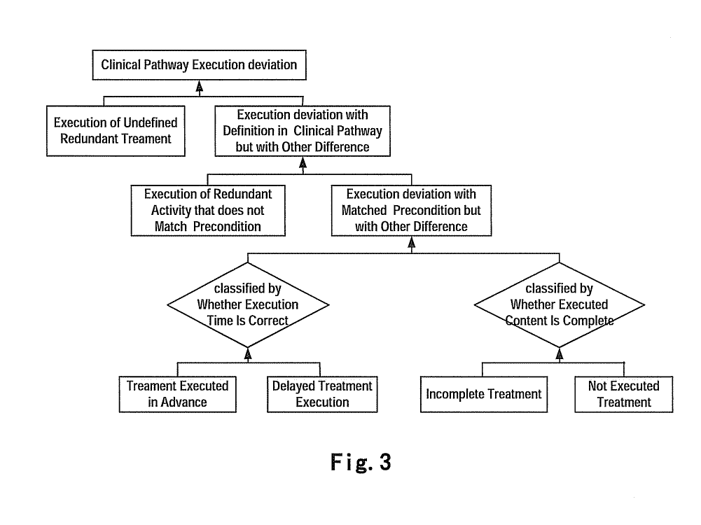

FIG. 3 illustrates relationships among the six types of clinical pathway execution deviation reports. An arrow represents an “isA” relationship, a block represents a deviation type, and a diamond represents different classification manners that may occur simultaneously. As described above, the output component 280 may output a clinical pathway execution deviation (if any) report to the user when the activity matching component 220 finds a match with an activity that represents the end of the procedure of clinical pathway execution. Or when a phase ends (for example, three days after admission, when the activity matching component 220 finds a match with an activity that marks the start of a phase, a timer may be trigger, and then the timer expires, the output component 280 may be triggered), the output component 280 outputs a clinical pathway execution deviation (if any) report to the user. Of course, those skilled in the art may understand that the output component 280 may present the clinical pathway execution deviation to the user in real time, without waiting for the complete end of the procedure of clinical pathway execution and/or waiting for the end of a phase. The output component 280 may even output the clinical pathway execution deviation report to the user based on a combination of these two manners.

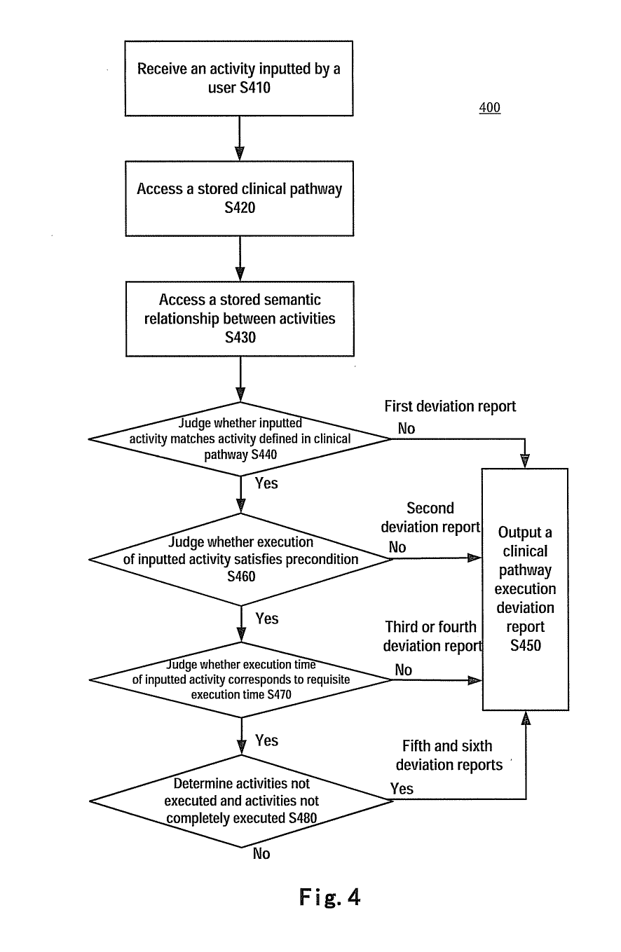

FIG. 4 illustrates a flowchart of a method 400 of identifying the deviation during clinical pathway execution according to one embodiment of the present invention.

As illustrated in FIG. 4, the method 400 comprises the steps of: receiving (S410) information inputted from a user (i.e., medical care personnel), accessing (S420) a stored clinical pathway, accessing (S430) semantic relationships between stored activities, and judging (S440), based on the semantic relationships between activities, whether the inputted activity matches a requisite activity as defined in the clinical pathway, and if the inputted activity does not match a requisite activity as defined in the clinical pathway, generating a first clinical pathway execution deviation report, wherein the first clinical pathway execution deviation report indicates that an undefined redundant activity is executed.

For example, the semantic relationships between activities may comprise SNOMED CT.

Further, the information inputted by the user preferably at least comprises names of activities, corresponding execution times, and corresponding names of clinical pathways (the names of the clinical pathways are for the first time, and thereafter, they can be names of instants).

Some activities (e.g., admission) mark the start of clinical pathway execution. Hence, such an activity is matched, a clinical pathway is instantiated and an instance name is assigned which can be, for example, clinical pathway name_id. Some activities (e.g., discharge) mark the end of clinical pathway execution. Hence, when such an activity is matched, it is triggered to output (step S450) a clinical pathway execution deviation (if any) report to the user. Of course, those skilled in the art may understand that it is possible to output the clinical pathway execution deviation report to the user in real time, without waiting for the complete end of the procedure of clinical pathway execution. It is even possible to output the clinical pathway execution deviation report to the user based on a combination of these two manners.

If the clinical pathway execution deviation report of the user is not outputted in real time, the clinical pathway execution deviation report may be temporarily stored.

The method 400 may further comprise judging (step S460) whether the execution of the inputted activity satisfies a precondition, and if it is determined that the execution of the inputted activity does not satisfy a precondition, generating a second clinical pathway execution deviation report (indicating that a redundant treatment activity not satisfying a precondition is executed).

As described above, the execution of some activities needs to satisfy preconditions. For example, a complete health check is required only when a blood sugar test fails.

The method 400 may further comprise judging (S470) whether the execution time of the inputted activity corresponds to the requisite execution time of the corresponding requisite activity as defined in the clinical pathway, and if it is determined that the two time do not match, generating one of a third clinical pathway execution deviation report and a fourth clinical pathway execution deviation report. The third clinical pathway execution deviation report indicates that the treatment activity is executed in advance, i.e., the execution time of the inputted activity is earlier than the requisite execution time of the corresponding requisite activity as defined in the clinical pathway. The fourth clinical pathway execution deviation report indicates that the execution of the treatment activity is delayed, i.e., the execution time of the inputted activity is later than the requisite execution time of the corresponding requisite activity as defined in the clinical pathway.

The method 400 may further comprise, upon arrival of a time point (for example, as described above, the user has inputted an activity (e.g., discharge) that marks the end during clinical pathway execution, or upon ending of a phase (for example, three days after admission; when an activity that marks the start of a phase is found, a timer may be triggered, and when the timer expires, this step may be triggered)), determining (step 5480) which requisite activities as defined in the clinical pathway are not executed or not completely executed up to this time point. When it is determined that a requisite activity as defined in the clinical pathway is not executed, a fifth clinical pathway execution deviation report is generated (indicating a requisite treatment activity defined in the clinical pathway, which is actually not executed). When it is determined that a requisite activity defined in the clinical pathway is not completely executed, a sixth clinical pathway execution deviation report is generated (indicating that a requisite treatment activity defined in the clinical pathway, which is not completely executed).

As described above, it is possible to determine that the inputted activity has an “isPartOf” relationship with the requisite activity defined in the corresponding clinical pathway. In other words, the inputted activity is a part of the requisite activity as defined in the corresponding clinical pathway. It is determined whether other part of the requisite activity defined in the corresponding clinical pathway is executed, and if no, it is determined that the requisite activity defined in the clinical pathway is not completely executed.

More specifically, when it is found that only one inputted activity exists, which has an “isPartOf” relationship with the requisite activity as defined in the corresponding clinical pathway, it may be determined definitely that the requisite activity defined in the corresponding clinical pathway is not completely executed. When it is found that a plurality of inputted activities exist, each of which have an “isPartOf” relationship with the requisite activity as defined in the corresponding clinical pathway, it is judged whether a combination of the plurality of inputted activities completely constitutes the requisite activity as defined in the corresponding clinical pathway. For example, by reviewing the semantic relationships, it is determined whether the combination of the plurality of inputted activities completely constitutes the requisite activity defined in the corresponding clinical pathway. When it is determined that the combination of the plurality of inputted activities completely constitutes the requisite activity as defined in the corresponding clinical pathway, then it is determined that the requisite activity defined in the corresponding clinical pathway is completely executed; otherwise, it is determined that the requisite activity defined in the corresponding clinical pathway is not completely executed.

Those skilled in the art should further understand that the present invention is not limited to the steps described above but also includes a combination of the above-described steps, rearrangements of the sequence, etc. The ultimate scope of the present invention is defined by the appended claims.

It should be noted that in order to facilitate easier understanding of the present invention, the foregoing description omits more detailed technical details that are well known to those skilled in the art and might be indispensable to the implementation of the present invention.

The specification of the present invention has been presented for purposes of illustration and description, and is not intended to be exhaustive or limited to the invention in the form as disclosed. Many modifications and variations will be apparent to those of ordinary skill in the art. Those skilled in the art should further understand that the method and means in embodiments of the present invention may be implemented as software, hardware, firmware, or a combination thereof. For example, the present invention may be implemented as a computer program product, which contains program code stored in a computer-readable medium and performing, when executed by a computer, the method described in embodiments of the present invention.

Therefore, the embodiments were chosen and described in order to best explain the principles of the invention, the practical application thereof, and to enable others of ordinary skill in the art to understand that all modifications and alterations made without departing from the spirit of the present invention are intended to fall into the protection scope of the present invention as defined in the appended claims.

What is claimed is:

1. A system for identifying a deviation during clinical pathway execution, comprising:
a receiver component configured to receive an activity inputted from a user;
a clinical pathway storage access component configured to access a stored clinical pathway which defines a requisite activity; and
an activity matching component configured to judge, based on a semantic relationship between activities, whether the inputted activity matches the requisite activity as defined in the clinical pathway, and generate, if it is determined that the inputted activity does not match the requisite activity defined in the clinical pathway, a clinical pathway execution deviation report to indicate that an activity not matching the requisite activity has been executed.

2. The system according to claim 1, further comprising:
a condition matching component configured to judge whether the execution of the inputted activity satisfies a precondition, and generate, if it is determined that the execution of the inputted activity does not satisfy the precondition, a clinical pathway execution deviation report to indicate that an activity not satisfying the precondition has been executed.

3. The system according to claim 2, further comprising:
a time matching component configured to judge whether an execution time of the inputted activity matches a requisite execution time of the corresponding requisite activity, and generate, if it is determined that the two execution times do not match, a clinical pathway execution deviation report to indicate that the execution time of the inputted activity does not match the requisite execution time of the corresponding requisite activity.

4. The system according to claim 1, further comprising:
a retrospect component configured to determine, when a time point arrives, a requisite activity defined in the clinical pathway that has not been completely executed until said time point, and generate, according to a result of determination, a clinical pathway execution deviation report to indicate that there is a requisite activity having not been completely executed.

5. The system according to claim 1, further comprising an output component configured to, in response to generating the clinical pathway execution deviation report, output the clinical pathway execution deviation report to the user.

6. The system according to claim 1, further comprising an output component configured to output the clinical pathway execution deviation report to the user after a phase of the clinical pathway ends.

7. The system according to any one of claims 1 to 6, wherein the semantic relationship is a subsumption relationship.

8. The system according to any one of claims 1 to 6, wherein the semantic relationship is a composition relationship.

9. A method of identifying a deviation during clinical pathway execution, the method comprising:
receiving an activity inputted from a user;
accessing a stored clinical pathway, the clinical pathway which defines a requisite activity; and
judging, based on a semantic relationship between activities, whether the inputted activity matches the requisite activity defined in the clinical pathway, and generating, if it is determined that the inputted activity does not match the requisite activity defined in the clinical pathway, a clinical pathway execution deviation report to indicate that an activity not matching the requisite activity has been executed.

10. The method according to claim 9, further comprising:
judging whether the execution of the inputted activity satisfies a precondition, and generating, if it is determined that the execution of the inputted activity does not satisfy the precondition, a clinical pathway execution deviation report to indicate that an activity not satisfying the precondition has been executed.

11. The method according to claim 9, further comprising:
judging whether an execution time of the inputted activity matches a requisite execution time of the corresponding requisite activity, and generating, if it is determined that the two execution times do not match, a clinical pathway execution deviation report to indicate that the execution time of the inputted activity does not match the requisite execution time of the corresponding requisite activity.

12. The method according to claim 9, further comprising:
when a time point arrives, determining a requisite activity defined in the clinical pathway that has not been completely executed until this time point, and according to a result of determination, and generating a clinical pathway execution deviation report to indicate that there is a requisite activity not having been completely executed.

13. The method according to claim 9, further comprising, in response to generating the clinical pathway execution deviation report, outputting the clinical pathway execution deviation report to the user.

14. The method according to claim 9, further comprising outputting the clinical pathway execution deviation report to the user after a phase of the clinical pathway ends.

15. The method according to claim 9, wherein the semantic relationship is a subsumption relationship.

16. The method according to claim 9, wherein the semantic relationship is a composition relationship.
